(19) United States
(12) Patent Application Publication
(10) Pub. No.: US 2003/0165413 A1
(43) Pub. Date: Sep. 4, 2003

(54) Process to recover vanadium contained in acid solutions

(76) Inventors: Benjamin Scharifker, Baruta Caracas (VE); Rossana Arenare, Baruta Caracas (VE)

Correspondence Address: BRINKS HOFER GILSON & LIONE, P.O. BOX 10395, CHICAGO, IL, 60610, US

(21) Appl. No.: 10/198,062

(22) Filed: Jul. 18, 2002

(30) Foreign Application Priority Data
Jul. 18, 2001 (VE) 2001-1539

(51) Int. Cl. C01G 31/02

(52) U.S. Cl. 423/65; 423/592.1

(57) ABSTRACT

A process for recovery of vanadium dissolved in acid solution or liquors by precipitating it out as vanadium pentoxide. Separation is carried out by adding calcium hydroxide, quicklime or calcium carbonate to the acid solution or liquor, producing a precipitate of vanadium pentoxide, which is separated from the liquid by physical methods such as filtration or centrifugation. If the acid is other than sulfuric acid, the calcium which remains dissolved in the solution or liquor by the addition of calcium hydroxide, quicklime or calcium carbonate, is removed by adding sulfuric acid, to produce solid calcium sulfate and water. The calcium sulfate is extracted from the solution or liquor or liquor by filtration or centrifugation. With sulfuric acid solution or liquors, after addition of the neutralizing agent, a solid precipitate of vanadium pentoxide and calcium sulfate is formed, which is then separated from the solution or liquor. The solid vanadium pentoxide is dissolved by adding sulfuric acid to the vanadium pentoxide and calcium sulfate precipitate and the solid calcium sulfate is separated from the resultant solution or liquor. Solid sodium hydroxide is added to the resultant solution or liquor and vanadium pentoxide is precipitated.

### SUMMARY

Applicants claim, under 35 U.S.C. §119, the benefit of priority of Venezuelan patent application Serial Number VE 2001-1539, filed on Jul. 18, 2001, the entire contents of which are incorporated herein by reference.

The procedure described relates to the recovery of vanadium dissolved in acid solutions by precipitating it directly as vanadium pentoxide. Recovery is carried out by addition of calcium hydroxide, quicklime or calcium carbonate to the acid solution or liquor, forming a precipitate of vanadium pentoxide, which is separated from the liquid by physical methods like filtration or centrifugation. If the acid is other than sulfuric acid, then the dissolved calcium that remains in the solution or liquor from addition of calcium hydroxide, quicklime or calcium carbonate, is removed by addition of sulfuric acid, yielding solid calcium sulfate and water. The calcium sulfate is extracted from the solution or liquor by filtration or centrifugation. The original composition of the acid solution is only modified by the lowering of its vanadium content, as well as by slight dilution due to formation of water, both from addition of calcium hydroxide, quicklime or calcium carbonate during the first step, as well as from addition of sulfuric acid during the second.

### TECHNICAL BACKGROUND

The present invention relates to separate vanadium from acid solutions containing it, such as, for example, typical liquors originated from the treatment of carbonaceous materials like fractions of heavy crude oil or residues obtained from oil refining processes (for example, petroleum coke). In these liquors, which also contain other metals like nickel, the typical dissolved vanadium contents usually exceeds 4%.

The recovery of vanadium from these solutions is of interest because of its relatively high concentration, thus representing an interesting source of this metal, which has diverse industrial applications, such as catalyst in oil refining processes, preparation of ferrous alloys (steel) and the construction of batteries.

The processes in the scientific literature for the recovery of vanadium comprise primarily precipitation with complexing agents like ammonia to form ammonium metavanadate. This procedure requires adjustment of the solution pH from its initial value, usually between zero and one, to a value close to two. The latter implies partial neutralization of the original acid content, meaning that the neutralized solution must be thrown away, which is not desirable.

According to the literature, the solid ammonium metavanadate is subsequently separated from the acid solution by physical means like filtration, centrifugation, etc., and then heated in air at temperatures between 600 and 650 degrees Celsius, in order to transform it into vanadium pentoxide, with evolution of ammonia.

The processes according to the present invention allow the recovery of vanadium from solution, whatever its oxidation state, by precipitating it directly as vanadium pentoxide.

With processes according to the present invention, less costly reagents than conventional methods are used, and the precipitation of vanadium pentoxide occurs at lower pH values, close to one, which allows reusing the original acid solution, thus reducing costs associated with the procedure as well as production of waste materials.

After recovering the vanadium pentoxide and when the acid present in the liquor is different from sulfuric, the accumulation of calcium that forms from addition of calcium hydroxide, quicklime or calcium carbonate is eliminated by addition of sulfuric acid in the vanadium-deprived liquor. In this way, precipitation of calcium sulfate is achieved, which can be easily separated from the solution by means of simple physical methods (solid-liquid separation), including filtration, centrifugation, and decantation. Therefore a liquor is obtained, with a composition that is identical to the original, except for its vanadium content and the slight dilution from addition of calcium hydroxide, quicklime or calcium carbonate during the first step, as well as sulfuric acid during the second.

In the method described in the literature to precipitate ammonium metavanadate, a liquid-liquid separation is required to withdraw form the original liquor the excess ammonia used as precipitating agent. These kind of separations are usually more complicated than the solid-liquid separations required here.

The calcium sulfate produced by the method according to the present invention has no harmful effects over the environment and can even be commercialized.

The percentage of vanadium recovered from the solution by the processes according to the present invention may be up to or greater than 98%.

### DESCRIPTION OF THE INVENTION

First, if necessary, the vanadium dissolved in the acid solution or liquor is oxidized to vanadium (V) passing air through the solution. In most cases the oxidation state of vanadium in these liquors is (V) and therefore this oxidation is not required.

The acid solution that contains vanadium can be concentrated or dilute, and may be composed by any inorganic acid, such as nitric, sulfuric, hydrochloric, phosphoric, hydrofluoric or by a mixture of them.

Calcium hydroxide, quicklime or calcium carbonate is added to the solution or liquor that contains the dissolved vanadium until the occurrence of a solid phase in the liquid. The quantity of calcium hydroxide, quicklime or calcium carbonate that is added depends on the concentration of vanadium and acid in the liquor.

Precipitation of the vanadium compound occurs as a result of the increase of pH. The pH value required for precipitation depends on the concentration of dissolved vanadium, according to the following equation:

VO₂⁺+H₂O→V₂O₅+2H⁺ (1)

When the acid present in the liquor is other than sulfuric acid, the solid precipitated by addition of the neutralizing agent is vanadium pentoxide.

After vanadium has precipitated, the solid is separated from the liquid phase by means of filtration, decantation, or centrifugation of the precipitate-containing solution. If required, the vanadium pentoxide obtained may be purified and crystallized by heating in air at temperatures between 500 and 1400 degrees Celsius, preferably 500 degrees Celsius.

When sulfuric acid is not present in the solution, the calcium that remains in the solution after precipitation of the vanadium pentoxide is precipitated by adding sulfuric acid to the solution after the vanadium pentoxide precipitate has been separated therefrom.

A stoichiometric amount of sulfuric acid is added to the solution based on the amount of neutralizing agent added to the solution.

With this addition, calcium sulfate is produced, a white-colored solid, which is separated from the liquor by means of a physical method such as filtration, decantation, centrifugation, etc. A small amount of water is also produced.

The resulting liquid or filtrate (acid solution or liquor) resulting after separation of calcium sulfate preserves the initial composition, except for the concentration of dissolved vanadium, which decreases over 98%, and by a slight dilution related with the amount of neutralizing agent (calcium hydroxide, quicklime or calcium carbonate) and by the sulfuric acid that is added.

If sulfuric acid is present in the liquor, besides precipitation of vanadium pentoxide, calcium sulfate also precipitates, thus a mixture of calcium sulfate and vanadium pentoxide is obtained. The proportion of calcium sulfate and vanadium pentoxide in the solid mixture depends both on the concentration of vanadium as well as the concentration of sulfuric acid originally present in the liquor.

Various methods can be used to separate the solid calcium sulfate and vanadium pentoxide from the solution. Preferably, the vanadium pentoxide is dissolved with an acid other than sulfuric acid and the solid calcium sulfate is filtrated from the solution. The dissolved vanadium in the solution can then be precipitated as vanadium pentoxide in accordance with the processes described herein.

When the acid in the liquor is sulfuric, the solution resulting from neutralization (addition of calcium hydroxide, quicklime or calcium carbonate) after extracting the solids has an acid content below its original value, due to consumption of sulfate ions during calcium precipitation. Thus the concentration of sulfuric acid decreases.

### EXAMPLE 1

Two hundred and fifty ml of an aqueous solution of 1% vanadium pentoxide and 20% nitric acid solution (initial pH of −0.3 units) were neutralized, adding slowly 37 g of calcium hydroxide while the change in pH was recorded. Once this amount of calcium hydroxide was added, the pH of the solution was 0.1 and precipitation of a brownish solid was observed.

This solid was filtered, dried and dehydrated by heating in a muffle to a temperature of 500 degrees Celsius. It was then weighed and characterized by its x-ray diffraction pattern as vanadium pentoxide.

To the resulting solution, after filtering the brownish solid, 28 ml of 97% sulfuric acid were added, and precipitation of a white solid was observed. This solid was then separated from the liquid, dried and characterized by its x-ray diffraction pattern as calcium sulfate.

With this procedure more than 90% of the original vanadium in the solution was successfully precipitated.

We claim:

1. A process that separates the vanadium contained in inorganic acid solutions different from sulfuric acid which consists in:
a. Oxidizing all the vanadium present in the solution to vanadium (V) by delivering through it an air current.
b. Adding calcium hydroxide, quicklime or calcium carbonate to the solution or liquor that contains the dissolved vanadium.
c. Separating the resulting solid after the addition described in ‘b’, vanadium pentoxide, by means of a physical method, solid-liquid separation.
d. Adding sulfuric acid to the liquid resulting from the filtration described in ‘c’
e. The quantity of sulfuric acid that is added in numeral ‘d’ is estimated according to the quantity of calcium hydroxide, quicklime or calcium carbonate that has been added in numeral ‘b’.
f. Separating the resulting solid in numeral ‘e’, calcium sulfate, with a physical method (solid-liquid separation).
g. Heating the solid obtained in numeral ‘c’, hydrated vanadium pentoxide, between 500 and 1400 degrees Celsius in air, preferably at 500 degrees Celsius, in order to dehydrate and crystallize it, thus converting it in crystalline vanadium pentoxide.

2. A process to separate the vanadium dissolved in solutions containing sulfuric acid consisting of:
a. Oxidizing all the vanadium present in solution or liquor to vanadium (V) by delivering an air current.
b. Adding calcium hydroxide, quicklime or calcium carbonate.
c. Separating the resulting solid, a mixture of vanadium pentoxide and calcium sulfate, by means of a physical method, solid-liquid separation.
d. Dissolving the solid obtained in numeral ‘c’ in an acid different from sulfuric to obtain solid calcium sulfate and dissolved vanadium pentoxide.
e. Separating the solid resulting in numeral ‘d’, calcium sulfate, with a physical method (solid-liquid separation).
f. Precipitating the vanadium pentoxide by adding to the solution obtained in numeral ‘d’ solid sodium hydroxide.

3. A process according to claim ‘1’ where the acid solution is selected between the following group of acids: nitric, hydrochloric, phosphoric and hydrofluoric, or a mixture of them.

4. A process for recovering vanadium from non-sulfuric acid inorganic acid solutions or liquors, comprising:
a. oxidizing the vanadium present in the solution or liquor to vanadium (V);
b. adding a neutralizing agent selected from the group consisting of calcium hydroxide, quicklime, calcium carbonate, and combinations thereof, to the solution or liquor;
c. precipitating solid vanadium pentoxide from the solution or liquor;
d. separating the solid vanadium pentoxide from the solution or liquor;
e. converting the separated solid vanadium pentoxide to crystalline vanadium pentoxide by heating the solid vanadium pentoxide to a temperature from about 500 degrees to about 1400 degrees Celsius.

5. The process of claim 7, wherein the vanadium in the solution or liquor is oxidized by passing air through the solution or liquor.

6. The process of claim 7 wherein the separating is accomplished by filtration, centrifugation, or decantation.

7. The process of claim 7 wherein the temperature is about 500 degrees Celsius.

8. The process of claim 7 further including:
a. adding sulfuric acid to the resultant solution from which solid vanadium pentoxide has been separated;
b. precipitating calcium sulfate from the resultant solution; and
c. separating the calcium sulfate from the resultant solution.

9. The process of claim 11 wherein the separation of calcium sulfate from the resultant solution is accomplished by filtration, centrifugation, or decantation.

10. The process of claim 7 wherein the non-sulfuric acid inorganic acid solution or liquor is derived from carbonaceous materials.

11. The process of claim 13 wherein the carbonaceous materials are crude oil, fractions of crude oil, residues from processing crude oil, residues from processing fractions of crude oil, cokes, mineral carbons, or bitumen sands.

12. The process of claim 7 wherein the acid solution or liquor is concentrated.

13. The process of claim 7 wherein the acid solution or liquor is dilute.

14. The process of claim 7 wherein the acid solution or liquor comprises nitric acid, hydrochloric acid, phosphoric acid, hydrofluoric acid, or combinations thereof.

15. A process for recovering vanadium from solutions or liquors containing sulfuric acid comprising:
a. oxidizing the vanadium in the solution or liquor to vanadium (V);
b. adding to the solution or liquor a neutralizing agent selected from the group consisting of calcium hydroxide, quicklime, calcium carbonate or combinations thereof to form a precipitate of calcium sulfate and vanadium pentoxide;
c. separating the vanadium pentoxide and calcium sulfate precipitate from the solution or liquor;
d. adding an acid other than sulfuric acid to the vanadium pentoxide and calcium sulfate precipitate to obtain solid calcium sulfate and dissolved vanadium pentoxide;
e. separating the solid calcium sulfate from the resultant solution obtained from step d;
f. adding sodium hydroxide to the resultant solution;
g. precipitating the vanadium pentoxide from the resultant solution;
h. separating the precipitated vanadium pentoxide from the resultant solution.

16. The process of claim 18 wherein the vanadium in the solution or liquor is oxidized by passing air through the solution or liquor.

17. The process of claim 18 wherein the separating of step e is accomplished by filtration, centrifugation, or decantation.

18. The process of claim 18 wherein the separating of step h is accomplished by filtration, centrifugation, or decantation.

19. The process of claim 18 wherein the inorganic acid solution or liquor is derived from carbonaceous materials.

20. The process of claim 22 wherein the carbonaceous materials are crude oil, fractions of crude oil, residues from processing crude oil, residues from processing fractions of crude oil, cokes, mineral carbons, or bitumen sands.

21. The process of claim 18 wherein the acid solution or liquor is concentrated.

22. The process of claim 18 wherein the acid solution or liquor is dilute.

23. A process for separating vanadium from non-sulfuric acid inorganic acid solutions containing oxidized vanadium, comprising:
a. adding a neutralizing agent selected from the group consisting of calcium hydroxide, quicklime, calcium carbonate, and combinations thereof, to the solution;
b. precipitating solid vanadium pentoxide from the solution;
c. separating the solid vanadium pentoxide from the solution;
d. converting the separated solid vanadium pentoxide to crystalline vanadium pentoxide by heating the solid vanadium pentoxide to a temperature from about 500 degrees to about 1400 degrees Celsius.

24. A process for recovering vanadium from sulfuric acid solutions containing oxidized vanadium comprising:
a. adding to the solution a neutralizing agent selected from calcium hydroxide, quicklime, calcium carbonate or combinations thereof;
b. separating solid vanadium pentoxide and calcium sulfate precipitate from the solution;
c. adding an acid other than sulfuric acid to the solid vanadium pentoxide and solid calcium sulfate precipitate to obtain solid calcium sulfate and dissolved vanadium pentoxide in solution;
d. separating the solid calcium sulfate from the resultant solution obtained from step c;
e. adding sodium hydroxide to the resultant solution;
f. precipitating solid vanadium pentoxide from the resultant solution;
g. separating the solid vanadium pentoxide from the resultant solution.
